(19) United States
(12) Patent Application Publication
(10) Pub. No.: US 2025/0345814 A1
(43) Pub. Date: Nov. 13, 2025

(54) POWDER SPRAY GUN AND POWDER SPRAY DEVICE

(71) Applicants: Toshihide YAMAMOTO, Kyoto-shi (JP); Chuzo TANIGUCHI, Kyoto-shi (JP); Takahiro OKABE, Kyoto-shi (JP); Hitoshi HIRAI, Kyoto-shi (JP); Ryohei NAGASE, Kyoto-shi (JP); Ryoma TANIMOTO, Kyoto-shi (JP); Suong-Hyu HYON, Minami-ku (JP); Motoki FUJIMURA, Minami-ku (JP); Kengo SHIRAISHI, Minami-ku (JP); Woogi HYON, Minami-ku (JP)

(72) Inventors: Toshihide YAMAMOTO, Kyoto-shi (JP); Chuzo TANIGUCHI, Kyoto-shi (JP); Takahiro OKABE, Kyoto-shi (JP); Hitoshi HIRAI, Kyoto-shi (JP); Ryohei NAGASE, Kyoto-shi (JP); Ryoma TANIMOTO, Kyoto-shi (JP); Suong-Hyu HYON, Minami-ku (JP); Motoki FUJIMURA, Minami-ku (JP); Kengo SHIRAISHI, Minami-ku (JP); Woogi HYON, Minami-ku (JP)

(21) Appl. No.: 19/197,834

(22) Filed: May 2, 2025

(30) Foreign Application Priority Data
May 8, 2024 (JP) 2024-075819

(51) Int. Cl. B05B 7/14

(52) U.S. Cl. CPC B05B 7/1422

(57) ABSTRACT

A housing supports a powder supply unit in a vibratable manner. An on/off switch switches between supply and non-supply of compressed gas with respect to a first gas flow path and a third gas flow path. A vibrator vibrates the powder supply unit by the compressed gas supplied from the third gas flow path. The powder supply unit supplies powder falling due to gravity to a disperser by the vibration of the powder supply unit. The disperser disperses the powder supplied from a powder supply port into the compressed gas entering from a first gas inlet of the first gas flow path. A second gas flow path further causes the compressed gas to flow into the first gas flow path through which the compressed gas in which the powder is dispersed flows.

### CROSS-REFERENCE TO RELATED APPLICATIONS

This application claims priority to Japanese Patent Application No. 2024-075819 filed on May 8, 2024 with Japan Patent Office. The entire disclosure of Japanese Patent Application No. 2024-075819 is hereby incorporated herein by reference.

### BACKGROUND

### Field of the Invention

The present invention relates to a powder spray gun that blows out powder with compressed gas and a powder spray device including the powder spray gun.

### Background Information

Conventionally, a powder spray device described in JP 7212407 B is known as a powder spray device including a powder spray gun that smoothly and uniformly blows out powder having low bulk density and low fluidity.

### SUMMARY

The powder spray device described in JP 7212407 B includes an electric vibration motor. This vibration motor vibrates a funnel member to which a vial is attached and a three-way joint connected to the funnel member, thereby achieving the powder spray gun that smoothly and uniformly blows out the powder having low bulk density and low fluidity.

Since the powder spray device described in JP 7212407 B includes the electric vibration motor and a battery, a sterilization method and conditions are restricted in a case where sterilization treatment is required for medical use or the like.

An object of the present disclosure is to provide a powder spray gun that does not include an electric mechanism to allow easy sterilization and smoothly and uniformly blows out powder, and a powder spray device including such a powder spray gun.

Hereinafter, a plurality of aspects will be described as means for solving the problem. These aspects can be combined in any manner if necessary.

A powder spray gun according to a first aspect includes a powder supply unit, a first gas flow path, a second gas flow path, a third gas flow path, a gas distribution path, a vibrator, an on/off switch, and a housing. The powder supply unit includes an upper attachment port to which a powder container is attachable or a storage in which powder is contained, a powder supply path through which the powder falling from the upper attachment port or the storage by gravity passes, and a powder supply port communicating with the powder supply path. The first gas flow path includes a first gas inlet, a disperser that disperses the powder supplied from the powder supply port into the compressed gas entering from the first gas inlet, and a discharge port that discharges the compressed gas in which the powder is dispersed. The second gas flow path has a second gas inlet, is connected to the first gas flow path between the discharge port and the disperser, and causes the compressed gas entering from the second gas inlet to flow into the first gas flow path. The vibrator generates a vibratory force for vibrating the powder supply unit and the disperser by the compressed gas. The third gas flow path has a third gas inlet and causes the compressed gas entering from the third gas inlet to flow into the vibrator. The gas distribution path is a flow path configured to distribute and supply the compressed gas to the first gas inlet, the second gas inlet, and the third gas inlet. The on/off switch is connected to at least the first gas inlet and the gas distribution path, and switches between supply and non-supply of the compressed gas at least from the gas distribution path to the first gas inlet. The housing accommodates the powder supply unit, the first gas flow path, the second gas flow path, the third gas flow path, and the vibrator, and supports the powder supply unit in a vibratable manner.

The powder spray gun according to the first aspect switches between the supply and the non-supply of the compressed gas from the gas distribution path to the first gas inlet at an appropriate timing by the on/off switch. Further, the vibrator can vibrate the powder supply unit supported by the housing in a vibratable manner by the compressed gas supplied from the third gas flow path to the vibrator. The vibration of the powder supply unit enables the powder to be smoothly supplied from the powder supply unit to the disperser in the first gas flow path. In a state where the spray gun is turned on, the compressed gas in the second gas flow path is added to the compressed gas in which the powder is uniformly dispersed in the disperser by the compressed gas flowing through the first gas flow path, whereby the compressed gas in which the powder is uniformly dispersed can be sufficiently blown out. In a state where the spray gun is turned off, a spray of the powder is stopped, and the compressed gas flows only to the second gas flow path, so that it is possible to prevent, for example, high-humidity air generated in a human body from flowing back into a nozzle. As described above, the powder spray gun according to the first aspect can be easily sterilized using the compressed gas as a power source for the vibration, and can smoothly and uniformly blow the powder.

A powder spray gun according to a second aspect is the powder spray gun according to the first aspect, in which an air volume of the third gas flow path is equal to or larger than a total air volume of the first gas flow path and the second gas flow path during a spray of the powder. The powder spray gun configured as described above can easily supply sufficient compressed gas from the third gas flow path to the vibrator, and can smoothly and uniformly blow out the powder in a stable manner.

A powder spray gun according to a third aspect is the powder spray gun according to the second aspect further including a flow rate adjustment hole in a flow passage including the gas distribution path, the on/off switch, the first gas flow path, the second gas flow path, and the third gas flow path to make the air volume of the third gas flow path be equal to or larger than the total air volume of the first gas flow path and the second gas flow path during the spray of the powder, the flow rate adjustment hole narrowing an inner diameter of the flow passage. The powder spray gun configured as described above can easily adjust the air volumes of the first gas flow path, the second gas flow path, and the third gas flow path to satisfy a desired relationship with a simple structure.

A powder spray gun according to a fourth aspect is the powder spray gun according to any one of the first to third aspects, in which the on/off switch includes a trigger lever, and is configured to cause the compressed gas to flow only to the second gas flow path when the trigger lever is in a trigger-off state, cause the compressed gas to flow to the first gas flow path, the second gas flow path, and the third gas flow path when the trigger lever is in a trigger-on state, and cause the compressed gas to be supplied to the first gas flow path simultaneously with or earlier than a start of supply of the compressed gas to the third gas flow path when the trigger-off state is switched to the trigger-on state. The powder spray gun configured as described above can supply the compressed gas to the first gas flow path before the vibration by the vibrator is applied to the powder supply unit and the disperser, and can smoothly and uniformly blow out the powder from the start of the supply of the compressed gas to the first gas flow path.

A powder spray gun according to a fifth aspect is the powder spray gun according to any one of the first to fourth aspects, in which the housing includes a separation unit that separates the second gas flow path and the powder supply unit not to overlap each other in a narrow portion of the housing. In the powder spray gun configured as described above, since the separation unit can prevent the second gas flow path and the powder supply unit from overlapping each other in the narrow portion of the housing, it is possible to prevent a situation in which the powder cannot be smoothly and uniformly blown out as the vibration of the powder supply unit and the disperser caused by the vibrator is limited by the second gas flow path and the housing.

A powder spray gun according to a sixth aspect is the powder spray gun according to any one of the first to fifth aspects, in which the vibrator includes a movement path having an annular shape, a weight that has a columnar shape and is disposed in the movement path, a blow hole connected to the third gas flow path to blow the compressed gas into the movement path, and an exhaust hole discharging the compressed gas from the movement path. The movement path has a rectangular cross section perpendicular to a moving direction of the weight having the columnar shape. The weight moves in the movement path by the compressed gas blown into the movement path from the blow hole. In the powder spray gun configured as described above, the columnar weight blocks the movement path so that the compressed gas leaking from a gap between the weight and the movement path can be reduced. In addition, the weight is less likely to be caught by the movement path since the weight has the columnar shape, so that the columnar weight rotates well by the compressed gas, and the vibrator efficiently vibrates.

A powder spray device according to a seventh aspect includes the powder spray gun according to any one of the first to sixth aspects, one external gas flow path, a compressed gas supply device, and one pressure regulator. The powder spray gun has one sterilizing filter that is disposed in the gas distribution path and sterilizes the compressed gas. The gas distribution path communicates with the first gas flow path, the second gas flow path, and the third gas flow path downstream of the sterilizing filter. The powder spray device configured as described above can include one pressure regulator and one sterilizing filter with a configuration branching into the first gas flow path, the second gas flow path, and the third gas flow path, so that an increase in the number of pressure regulators and sterilizing filters can be prevented.

The powder spray gun and the powder spray device according to the present disclosure can be easily sterilized and can smoothly and uniformly blow out powder.

### BRIEF DESCRIPTION OF THE DRAWINGS

FIG. 1 is a right side view illustrating an example of a powder spray device according to a first embodiment;

FIG. 2 is a right side view illustrating an example of a powder spray gun according to the first embodiment in a state where a first housing portion is detached;

FIG. 3 is a cross-sectional view illustrating an example of a cross-sectional configuration of a vial, a powder supply unit, and a disperser according to the first embodiment;

FIG. 4 is an enlarged cross-sectional view illustrating the powder supply unit of FIG. 3 in an enlarged manner;

FIG. 5 is an enlarged perspective view illustrating the powder supply unit of FIG. 3 in an enlarged manner;

FIG. 6 is a schematic diagram illustrating an outline of a configuration of the powder spray device according to the first embodiment;

FIG. 7 is an enlarged exploded perspective view illustrating a vibrator according to the first embodiment in an enlarged manner;

FIG. 8 is a perspective view of a vibration case of the vibrator illustrated in FIG. 7;

FIG. 9 is a side view of the vibration case of the vibrator illustrated in FIG. 7;

FIG. 10 is a view for describing a configuration of the vibration case of the vibrator;

FIG. 11 is a side view illustrating an example of an on/off switch illustrated in FIG. 2;

FIG. 12 is a perspective view of two types of joint parts used in the on/off switch;

FIG. 13 is a schematic diagram illustrating an outline of a configuration of a powder spray device according to a second embodiment;

FIG. 14 is a schematic diagram illustrating an outline of a configuration of a powder spray device according to a third embodiment;

FIG. 15 is a perspective view illustrating an example of a vibrator according to Modification B;

FIG. 16 is a perspective view illustrating another example of the vibrator according to Modification B; and

FIG. 17 is a side view illustrating an example of an on/off switch according to Modification C.

### DETAILED DESCRIPTION OF EMBODIMENTS

### First Embodiment

### (1) Overall Configuration of Powder Spray Device

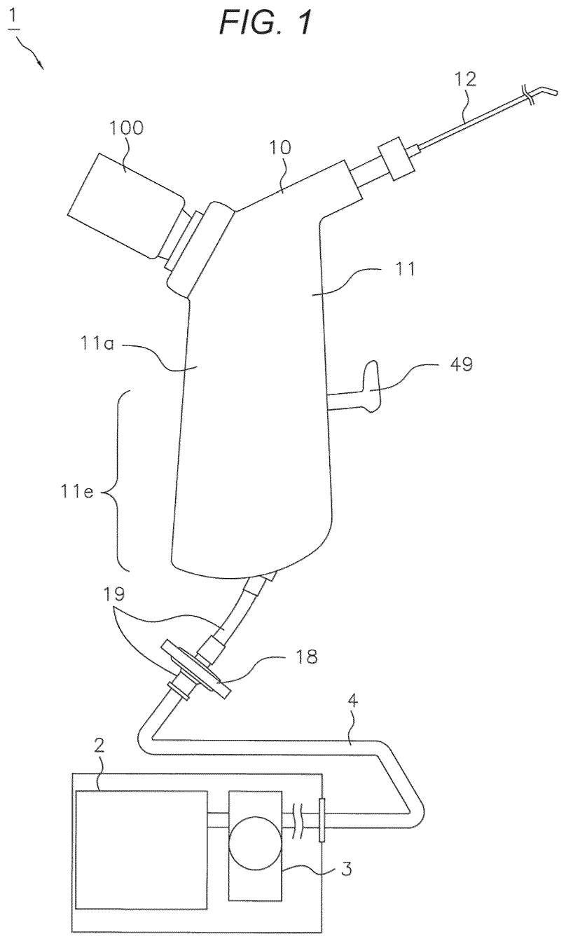

As illustrated in FIG. 1, a powder spray device 1 of a first embodiment includes a powder spray gun 10, an external gas flow path 4, a pressure regulator 3, and a compressed gas supply device 2. The powder spray device 1 of the first embodiment has a configuration in which compressed gas flows into a gas distribution path 19 of the powder spray gun 10 through the single external gas flow path 4. Examples of the compressed gas include compressed air, compressed nitrogen, and compressed carbon dioxide. The powder spray device 1 is configured such that the powder spray gun 10 can be detached from the powder spray device 1 by separating the powder spray gun 10 between the gas distribution path 19 and the external gas flow path 4. For example, the powder spray gun 10 can be attached and detached for each surgery to replace the powder spray gun 10 in the powder spray device 1.

The compressed gas supply device 2 is connected to the external gas flow path 4 and supplies the compressed gas to the external gas flow path 4. The compressed gas supply device 2 includes, for example, a compressor and a gas storage unit, or a gas cylinder.

The single pressure regulator 3 is disposed in the external gas flow path 4. The pressure regulator 3 adjusts the pressure of the compressed gas supplied from the external gas flow path 4 to the gas distribution path 19.

The powder spray device 1 is a device that sprays powder contained in a vial 100 (an example of a powder container) together with the compressed gas from a nozzle 12 of the powder spray gun 10. The vial 100 has a volume of, for example, 3 to 50 mL, and an inner diameter of a mouth 102 is, for example, 3 to 25 mm.

### (2) Outline of Powder Spray Gun

As illustrated in FIG. 1, the powder spray gun 10 includes the gas distribution path 19 to which the compressed gas is supplied, a housing 11 into which the gas distribution path 19 is inserted, the nozzle 12 attached to the housing 11, a trigger lever 49 attached to the housing 11, and a sterilizing filter 18 disposed in the gas distribution path 19.

In the housing 11 of the powder spray gun 10, the compressed gas supplied through the gas distribution path 19 and the powder in the vial 100 are mixed. The compressed gas and the powder mixed in the housing 11 are sprayed from the powder spray gun 10 to a desired place through the nozzle 12. The desired place is, for example, an affected area to which drug powder is to be applied in a case where the powder is the drug powder. An operator of the powder spray gun 10 can grip the housing 11 and move the powder spray gun 10 to cause the powder spray gun 10 to take a desired posture. The operator of the powder spray gun 10 can operate the trigger lever 49 to blow out the compressed gas in which the powder is dispersed from the nozzle 12.

The sterilizing filter 18 of the powder spray gun 10 has a function of removing microorganisms and fine particles in the compressed gas. For example, when the powder spray gun 10 is used for surgery, an infection risk can be reduced by supplying the compressed gas purified through the sterilizing filter 18.

### (3) Configuration of Powder Spray Gun

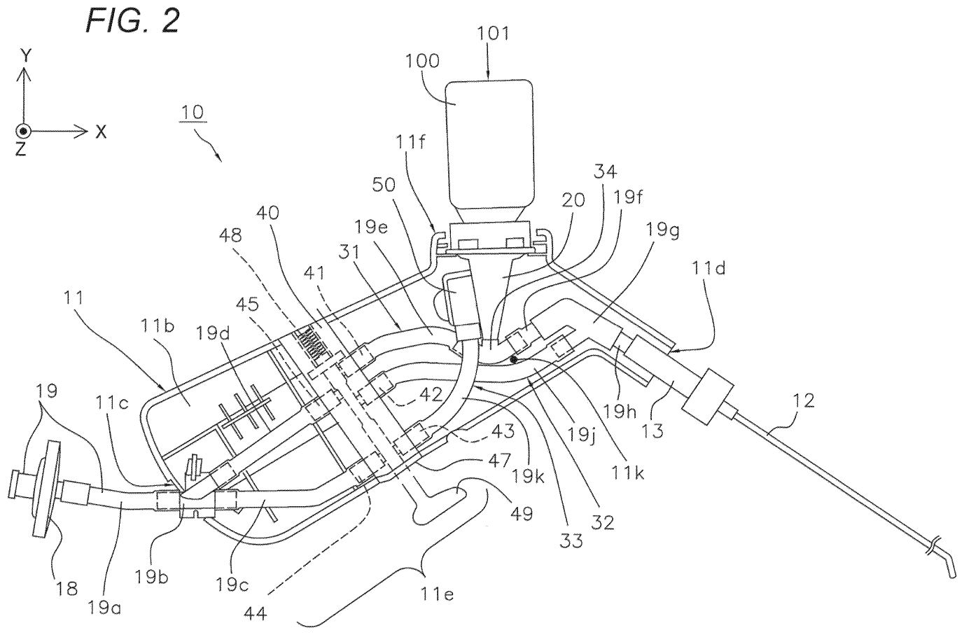

FIG. 2 illustrates a state where a part of the housing 11 of the powder spray gun 10 is detached to expose the inside of the housing 11. In order to facilitate understanding of the description, directions indicated by arrows in FIG. 2 are referred to as an X direction, a Y direction, and a Z direction, respectively.

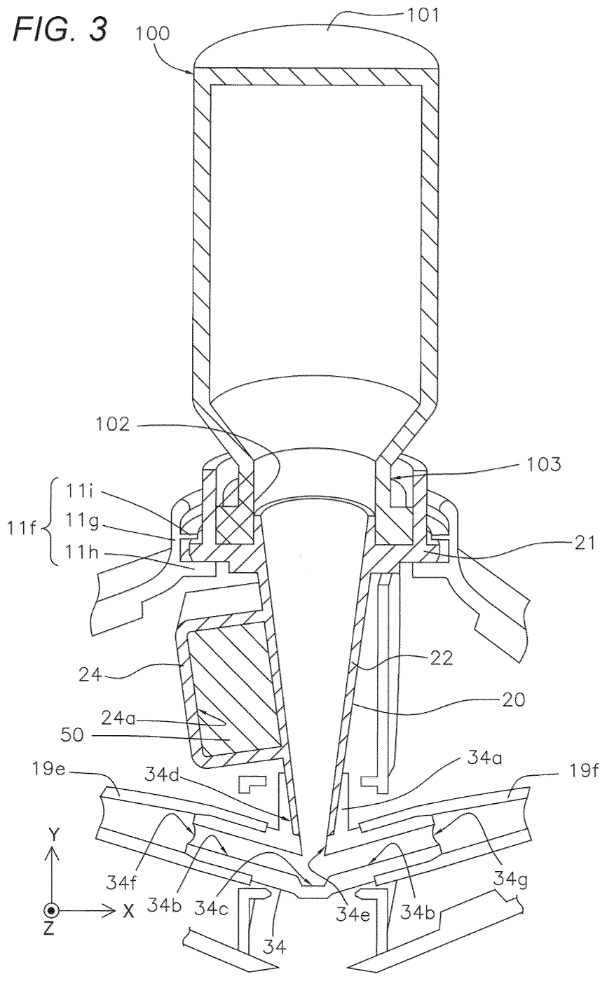

FIG. 3 illustrates an enlarged view of the configuration of the powder spray gun 10 in the periphery of the vial 100.

The states illustrated in FIGS. 2 and 3 is a state where a bottom 101 of the vial 100 is disposed vertically upward (in the Y direction) and the mouth 102 of the vial 100 is disposed vertically downward (in a direction opposite to the Y direction). The powder contained in the vial 100 is pulled by gravity and supplied from the mouth 102 of the vial 100 to the powder spray gun 10. Here, a case where the powder spray gun 10 is operated with the vial 100 along the vertical direction will be described. However, even when the vial 100 is operated in a state of being inclined with respect to the vertical direction, the powder falls from the mouth 102 of the vial 100 toward the powder spray gun 10 if the inclination is set to the extent that the powder flows toward the mouth 102.

The powder spray gun 10 includes a powder supply unit 20, a first gas flow path 31, a second gas flow path 32, a third gas flow path 33, a vibrator 50, and an on/off switch 40 including the trigger lever 49, in addition to the housing 11, the nozzle 12, the sterilizing filter 18, and the gas distribution path 19 described above.

### (3-1) Configuration of Powder Supply Unit

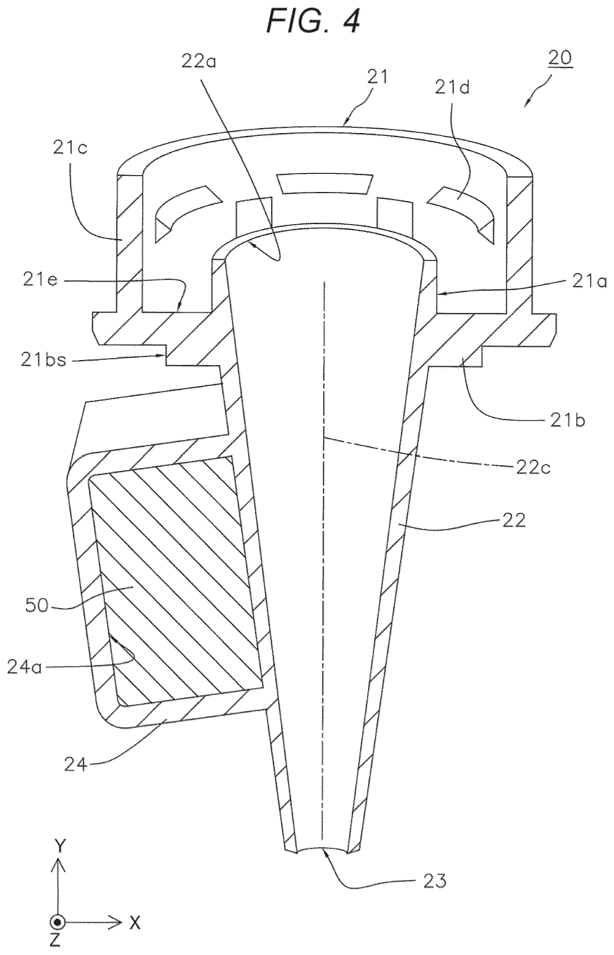

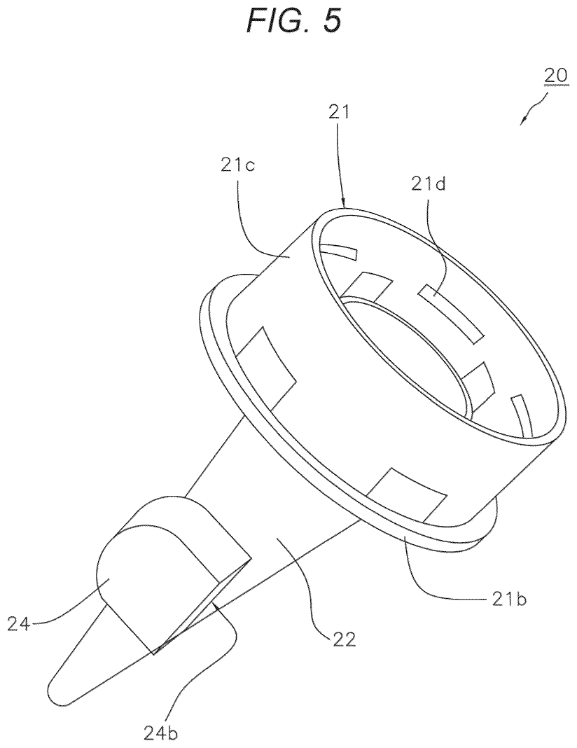

FIG. 4 is an enlarged view of the powder supply unit 20 illustrated in FIG. 3. FIG. 5 illustrates an outer shape of the powder supply unit 20.

The powder supply unit 20 includes an upper attachment port 21, a powder supply path 22, a powder supply port 23, and a pocket 24. The powder supply unit 20 is a member integrally molded with resin. The powder supply unit 20 is integrally formed by, for example, injection molding of a polypropylene resin using a mold.

### (3-1-1) Powder Supply Path 22

The powder supply path 22 is a funnel portion having a truncated cone shape. The expression “truncated cone” indicating the shape of the powder supply path 22 can also be rephrased as a cone having a cut edge at its tip. The powder supply path 22 illustrated in FIGS. 4 and 5 can also be rephrased as a funnel member. The powder supply path 22 is a path through which the powder falling from the upper attachment port 21 passes. A lower opening of the powder supply path 22 is the powder supply port 23. The powder is supplied from the powder supply path 22 to the first gas flow path 31 through the powder supply port 23. An inner diameter of the upper opening 22a of the funnel-shaped powder supply path 22 is larger than an inner diameter of the powder supply port 23. An outer periphery of the upper opening 22a has a shape to be in close contact with an inner surface of the mouth 102 of the vial 100.

The periphery of the powder supply port 23, which is a distal end of the powder supply path 22, is a place that is the thinnest in the powder supply path 22. The powder supply port 23 communicates with the powder supply path 22, and is a place where the powder supplied through the powder supply path 22 is fed into the first gas flow path 31.

A mold surface corresponding to an inner surface of the powder supply path 22 is subjected to, for example, mirror finishing. Through such a manufacturing process, the inner surface of the truncated cone-shaped powder supply path 22 can have a center line average roughness Ra defined in JISB0601 of, for example, about 10 nm. In the illustrated example, a taper angle (angle with respect to a central axis 22c) of the inner surface of the powder supply path 22 is, for example, about 10 degrees.

### (3-1-2) Configuration of Upper Attachment Port

The upper attachment port 21 includes a cylindrical portion 21a in the periphery of the upper opening of the powder supply path 22, an outward flange 21b extending from an outer peripheral surface of the powder supply path 22, and a cylindrical standing wall 21c extending from the outward flange 21b. In FIG. 4, the central axis 22c of the truncated cone-shaped powder supply path 22 is indicated by an alternate long and short dash line. The cylindrical standing wall 21c has a central axis that coincides with the central axis 22c of the truncated cone-shaped powder supply path 22, and extends in a direction (the Y direction) in which the central axis 22c extends. The cylindrical portion 21a of the powder supply path 22 is also a part of the upper attachment port 21.

A groove 21e extending in a circular ring shape is formed by the cylindrical portion 21a, a part of the outward flange 21b, and a part of the cylindrical standing wall 21c. The cylindrical portion 21a is inserted into the mouth 102 of the vial 100, and the periphery of the mouth 102 of the vial 100 is fitted into the circular ring-shaped groove 21e, whereby the vial 100 is fixed to the upper attachment port 21. A plurality of locking protrusions 21d protrude from an inner peripheral surface of the cylindrical standing wall 21c, and a width of the groove 21e is narrowed at a place of the locking protrusions 21d. An outer diameter of an outer periphery of the mouth 102 of the vial 100 is larger than that of an outer periphery of a neck 103 of the vial 100 continuous with the periphery of the mouth 102. Since a diameter of a circle connecting distal ends of the plurality of locking protrusions 21d is smaller than that of the outer periphery of the mouth 102 of the vial 100, in a state where the mouth 102 is fitted into the groove 21e over the locking protrusions 21d, the locking protrusions 21d are caught by the mouth 102, and the vial 100 hardly comes off from the groove 21c.

### (3-1-3) Configuration of Pocket

The pocket 24 is provided on the outer peripheral surface of the powder supply path 22. In order to prevent the pocket 24 from being detached from the powder supply path 22 due to vibration, it is preferable that the pocket 24 and the powder supply path 22 be integrally molded. The pocket 24 is a portion that holds the vibrator 50. At least a part of the vibrator 50 is accommodated in an internal space 24a of the pocket 24. In FIGS. 3 and 4, a cross section of the vibrator 50 is schematically indicated by hatching, and the detailed structure is omitted. The pocket 24 has, for example, a box shape one surface of which is open. The vibrator 50 is press-fitted into the pocket 24 from an opening 24b of the pocket 24 to be firmly fixed. In other words, the vibrator 50 fitted into the pocket 24 is tightened and firmly fixed to the pocket 24. However, a method of fixing the pocket 24 to the vibrator 50 is not limited to press-fitting. For example, the pocket 24 may be fixed to the vibrator 50 using an adhesive or a protrusion. Since the pocket 24 is attached in an inclined manner with respect to the central axis 22c of the powder supply path 22, a direction of a force exerted by the vibrator 50 also includes a direction inclined with respect to the central axis 22c.

### (3-2) Configuration of Housing

The housing 11 accommodates at least a part of the gas distribution path 19, the powder supply unit 20, the first gas flow path 31, the second gas flow path 32, the third gas flow path 33, the on/off switch 40, and the vibrator 50. The housing 11 supports the powder supply unit 20 in a vibratable manner.

The housing 11 is formed by combining two first housing portion 11a and second housing portion 11b like a bivalve. The state illustrated in FIG. 2 is a state where the first housing portion 11a is moved in the Z direction and detached to leave the second housing portion 11b. For example, the first housing portion 11a and the second housing portion 11b are formed of resin by injection molding using separate molds.

An inlet opening 11c for passage of the gas distribution path 19 is provided in an upstream portion of the housing 11. A nozzle opening 11d for attachment of the nozzle 12 is provided in a downstream portion of the housing 11. The on/off switch 40 is provided downstream of the inlet opening 11c and upstream of the nozzle opening 11d. A part of the housing 11 from the most upstream place of the housing 11 where the inlet opening 11c is provided to the vicinity of a place where the on/off switch 40 is provided forms a handle Ile. The operator grips the handle Ile to operate the powder spray gun 10.

In the nozzle opening 11d of the housing 11, a joint 13 for attachment of the nozzle 12 is fixed to the second housing portion 11b. The nozzle 12 is detachably attached to the joint 13.

The housing 11 is provided with a support portion 11f that supports the powder supply unit 20 between the on/off switch 40 and the nozzle opening 11d. The support portion 11f includes a cylindrical outer peripheral wall 11g, a first inward flange 11h, and a second inward flange 11i. The outer peripheral wall 11g rises in the direction (Y direction) in which the central axis 22c of the powder supply path 22 extends. An end portion of the outer peripheral wall 11g is curled inward. The first inward flange 11h and the second inward flange Ili protrude inward from the outer peripheral wall 11g. The first inward flange 11h is disposed on the inner side of the housing 11 with respect to the second inward flange Ili.

The outward flange 21b of the upper attachment port 21 is disposed between the first inward flange 11h and the second inward flange 11i. A surface on the inner side of the outward flange 21b is supported on a surface on the outer side of the first inward flange 11h in a vibratable manner. The second inward flange 11i restricts the outward flange 21b from the outer side such that the powder supply unit 20 does not pop out of the housing 11.

The powder supply unit 20 to which the vial 100 is fixed is swingable in a direction (in-plane direction of an XZ plane) radially extending from the central axis 22c of the powder supply path 22 as the outward flange 21b slides on the first inward flange 11h. The reason why the powder supply unit 20 can swing with respect to the housing 11 is that there is a gap (clearance) between the standing wall 21c of the powder supply unit 20 and the second inward flange 11i, and there is a gap between the standing wall 21c and the curled end of the outer peripheral wall 11g. In addition, a step 21bs is provided on a surface on the inner side of the outward flange 21b, and a gap is provided between a distal end of the first inward flange 11h and the step 21bs. A sliding range of the first inward flange 11h is restricted by the step 21bs.

A dimensional range in which the powder supply unit 20 is swingable in the up-down direction due to the gap is 0.5 to 8 mm, preferably 1 to 5 mm, and particularly preferably 2 to 4 mm. A dimensional range in which the powder supply unit 20 is swingable in a direction perpendicular to the central axis 22c of the powder supply path 22 due to the gap (the in-plane direction of the XZ plane) is 0.5 to 5 mm, preferably 0.5 to 4 mm, and particularly preferably 2 to 3 mm.

### (3-3) Flow Passage Inside Housing

A flow passage inside the housing includes the gas distribution path 19, the on/off switch 40, the first gas flow path 31, the second gas flow path 32, and the third gas flow path.

### (3-3-1) First Gas Flow Path

The first gas flow path 31 includes a fourth tube 19e, a disperser 34, a fifth tube 19f, a second three-way joint 19g, and a sixth tube 19h.

The disperser 34 has a socket 34a, an airflow conduit 34b, and a recess 34c. In the socket 34a, an inner peripheral surface of an insertion port 34d into which the distal end of the truncated cone-shaped powder supply path 22 is inserted has a truncated cone shape similar to that of the powder supply path 22, and an inner peripheral surface of the insertion port 34d is in close contact with the outer peripheral surface of the inserted powder supply path 22. The insertion port 34d of the socket 34a communicates with a powder inlet 34c. The powder inlet 34c is an opening through which a bottom of the insertion port 34d communicates with the airflow conduit 34b. The powder inlet 34e forms an opening of a wall of the airflow conduit 34b in the disperser 34. Inner peripheral surfaces of the powder inlet 34e and the powder supply path 22 are configured to be continuous with each other in a state where the powder supply path 22 is inserted into the socket 34a. In this state, the powder supply port 23 extends to a position substantially in contact with the airflow conduit 34b.

Since the disperser 34 is fixed to the powder supply unit 20, when the powder supply unit 20 is vibrated by the vibrator 50, the vibration is transmitted to the disperser 34, and the disperser 34 also vibrates.

In the airflow conduit 34b, the recess 34c is formed on the wall of the airflow conduit 34b at a place facing the powder supply port 23. The recess 34c is a portion recessed from the wall of the airflow conduit 34b. The airflow conduit 34b is slightly bent at the portion of the recess 34c, and the airflow conduit 34b on the upstream side of the recess 34c and the airflow conduit 34b on the downstream side intersect at an angle smaller than 180 degrees. The disperser 34 having such a configuration disperses the powder in the compressed gas.

The fourth tube 19e communicates with a first joint 41 of the on/off switch 40. A portion of the fourth tube 19e connected to the first joint 41 is a first gas inlet of the first gas flow path 31. The fourth tube 19e communicates with an inflow port 34f of the airflow conduit 34b. An outflow port 34g of the airflow conduit 34b communicates with the fifth tube 19f. The fifth tube 19f communicates with a first inlet of the second three-way joint 19g. An outlet of the second three-way joint 19g communicates with the sixth tube 19h. The sixth tube 19h communicates with the joint 13. Here, a discharge port of the sixth tube 19h in a portion connected to the joint 13 is a discharge port of the first gas flow path 31. Note that the first gas flow path 31 may include up to the nozzle 12, and an air outlet of the nozzle 12 may be regarded as the discharge port of the first gas flow path 31.

In the first gas flow path 31, the compressed gas is supplied from the portion (first gas inlet) of the fourth tube 19e connected to the first joint 41. The disperser 34 disperses the powder supplied from the powder supply port 23 into the compressed gas entering the disperser 34 from the fourth tube 19e. The compressed gas in which the powder is dispersed flows into the second three-way joint 19g through the first inlet from the disperser 34 via the fifth tube 19f. The compressed gas in which the powder is dispersed is discharged through the outlet of the second three-way joint 19g from the joint 13 to the nozzle 12 via the sixth tube 19h.

In order to facilitate the vibration of the disperser 34 and the powder supply unit 20, it is preferable to use a flexible tube excellent in followability to vibration for the fourth tube 19e and the fifth tube 19f. Examples of the flexible tube include a tube made of urethane rubber, a silicone tube, and a PVC tube (particularly, a non-phthalic acid-based soft vinyl chloride resin tube).

### (3-3-2) Second Gas Flow Path

A seventh tube 19j communicates with a second joint 42 of the on/off switch 40. A portion of the seventh tube 19j connected to the second joint 42 is a second gas inlet of the second gas flow path 32. The seventh tube 19j communicates with a second inlet of the second three-way joint 19g. Causing the compressed gas to flow from the seventh tube 19j to the second three-way joint 19g is an example of causing the compressed gas entering through the second gas inlet to flow to the first gas flow path 31 by connection to the first gas flow path 31 between the discharge port of the first gas flow path 31 and the disperser 34.

### (3-3-3) Third Gas Flow Path

The third gas flow path 33 is a flow path through which the compressed gas flows to the vibrator 50. An eighth tube 19k communicates with a third joint 43 of the on/off switch 40. A portion of the eighth tube 19k connected to the third joint 43 is a third gas inlet of the third gas flow path 33. The eighth tube 19k causes the compressed gas to flow in as a power source of the vibrator 50.

### (3-3-4) Vibrator

The vibrator 50 generates a vibratory force for vibrating the powder supply unit 20 and the disperser 34 by the compressed gas. Details of the configuration of the vibrator 50 will be described later.

### (3-3-5) Separation Unit

The housing 11 includes a pin 11k as a separation unit that separates the second gas flow path 32 and the powder supply unit 20 so as not to overlap each other at a narrow portion of the housing 11. The pin 11k is disposed between the second gas flow path 32 and the powder supply unit 20. The narrow portion of the housing 11 is a space in the Z direction of the housing 11. When the movement of the powder supply unit 20 is hindered, the vial 100 does not sufficiently vibrate, the amount of falling (a supply to the disperser 34) of the powder in the vial 100 becomes insufficient, and it may be impossible to spray an appropriate amount of the powder. Note that the separation unit is not limited to the pin 11k. As the separation unit other than the pin, for example, a rib, a holder, a fixing band, or a cable clip can be used.

### (3-3-6) Gas Distribution Path

The gas distribution path 19 is a flow path that distributes and supplies the compressed gas to the first gas flow path 31, the second gas flow path 32, and the third gas flow path 33. The gas distribution path 19 includes a first tube 19a, a second tube 19c, a third tube 19d, and a first three-way joint 19b. The first three-way joint 19b is fixed to the second housing portion 11b in the vicinity of the inlet opening 11c. The first tube 19a extending from the sterilizing filter 18 communicates with an inlet of the first three-way joint 19b. The compressed gas entering the first three-way joint 19b bifurcates at the first three-way joint 19b and is sent out from a first outlet and a second outlet. The second tube 19c communicates with the first outlet of the first three-way joint 19b, and the third tube 19d communicates with the second outlet of the first three-way joint 19b.

The second tube 19c communicates with a fourth joint 44 of the on/off switch 40. The third tube 19d communicates with a fifth joint 45 of the on/off switch 40. The gas distribution path 19 distributes the compressed gas to the first gas flow path 31 and the second gas flow path 32 through the first tube 19a, the first three-way joint 19b, and the second tube 19c. Further, the gas distribution path 19 distributes the compressed gas to the third gas flow path 33 through the first tube 19a, the first three-way joint 19b, and the third tube 19d.

### (3-3-7) On/Off Switch

The on/off switch 40 is connected to the first gas flow path 31, the second gas flow path 32, the third gas flow path 33, and the gas distribution path 19. The on/off switch 40 is a mechanism that switches between supply and non-supply of the compressed gas from the gas distribution path 19 to each of the first gas flow path 31 and the third gas flow path 33.

The on/off switch 40 includes a valve case 47, a coil spring 48, and the trigger lever 49. The trigger lever 49 includes a flat portion on which a finger is placed and a rod-shaped portion extending from the flat portion into the housing 11. A distal end of the coil spring 48 is locked to a distal end of the rod-shaped portion. When the flat portion of the trigger lever 49 is pushed with the finger, the coil spring 48 is elastically deformed. When the push of the trigger lever 49 is stopped, the elastic deformation of the coil spring 48 due to the push is released, and the trigger lever 49 returns to a position before the push. A state before the trigger lever 49 is pushed is a trigger-off state, and a state after the trigger lever 49 is pushed is a trigger-on state.

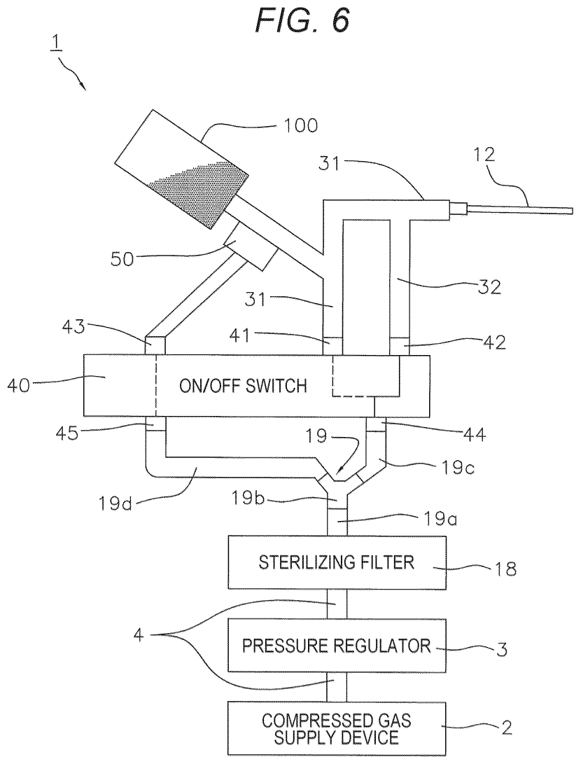

FIG. 6 schematically illustrates a path through which the compressed gas flows and main instrument members related to the compressed gas. In the on/off switch 40 of FIG. 6, the compressed gas flows in both the trigger-off state and the trigger-on state in a flow path indicated by a solid line, and the compressed gas does not flow in the trigger-off state but flows in the trigger-on state in flow paths indicated by broken lines.

The on/off switch 40 is configured to allow the compressed gas entering from the fourth joint 44 to flow to the first joint 41 and the second joint 42. The on/off switch 40 is configured to allow the compressed gas entering from the fifth joint 45 to flow to the third joint 43.

Before the trigger lever 49 is pushed (at the trigger-off time), the compressed gas flows from the fourth joint 44 to the second joint 42. At the trigger-off time, the compressed gas does not flow to the first joint 41 and the third joint 43. In other words, at the trigger-off time, the second joint 42 is in an open state, and the first joint 41 and the third joint 43 are in a closed state.

Note that a structure of the on/off switch 40 will be described later.

### (3-4) Detailed Configuration of Vibrator

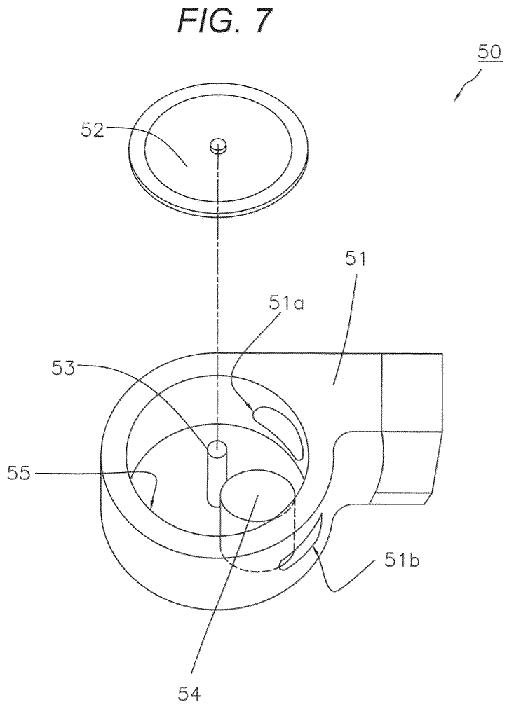

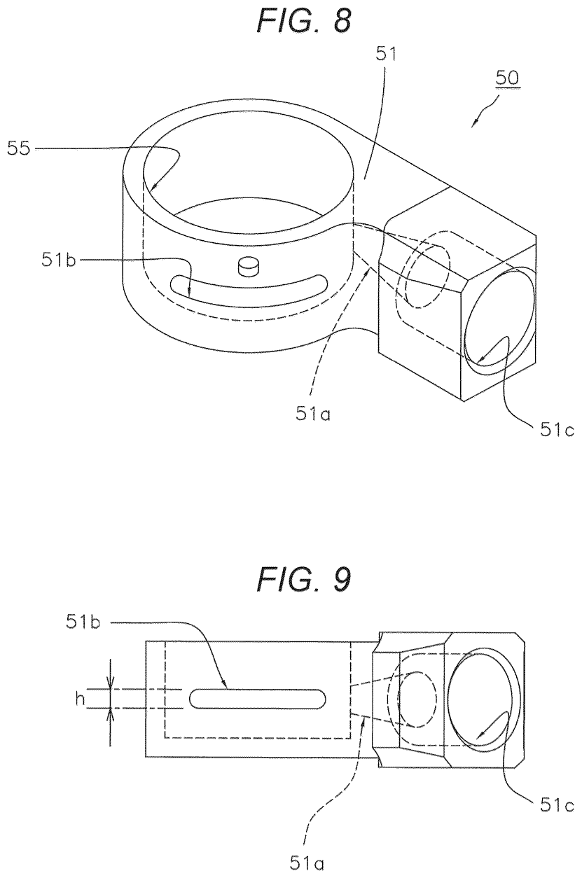

The vibrator 50 is a member that generates the vibratory force for vibrating the powder supply unit 20 and the disperser 34 by the compressed gas. FIGS. 7, 8, and 9 illustrate the vibrator 50 and components thereof. The vibrator 50 includes a vibration case 51, a lid 52, a central column 53, and a columnar weight 54. An annular movement path 55 in which the weight 54 moves is formed by the vibration case 51, the lid 52, and the central column 53. Here, a case where the movement path 55 has an annular shape will be described, but a track of the movement path 55 is not necessarily circular and may be, for example, elliptical. It is preferable to use metal having a large specific gravity for the weight 54 in order to facilitate vibration. Examples of metal used for the weight 54 include stainless steel. However, a material of the weight 54 is not limited to metal. The material of the weight 54 may be, for example, ceramic or a composite material of metal and resin. When the annular movement path 55 is cut along a plane passing through a central axis of the central column 53, a rectangular opening is formed. A shape of the rectangular opening substantially coincides with a shape of a cross section cut along a plane passing through the central axis of the columnar weight 54. The annular movement path 55 has a shape capable of suppressing leakage of gas from a gap between the weight 54 and an inner wall of the annular movement path 55 while suppressing friction between the inner wall of the annular movement path 55 and the weight 54.

The vibration case 51 has a blow hole 51a through which the compressed gas is introduced into the annular movement path 55 and an exhaust hole 51b through which the compressed gas is discharged from the annular movement path 55. The exhaust hole 51b is disposed near the blow hole 51a. The exhaust hole 51b is an elongated hole extending along a movement trajectory of the weight 54. A height of the exhaust hole 51b is, for example, about 1 mm. A height h of one exhaust hole 51b is preferably ½ or less of a height of the columnar weight 54 in order for smooth movement without being caught by the exhaust hole 51b.

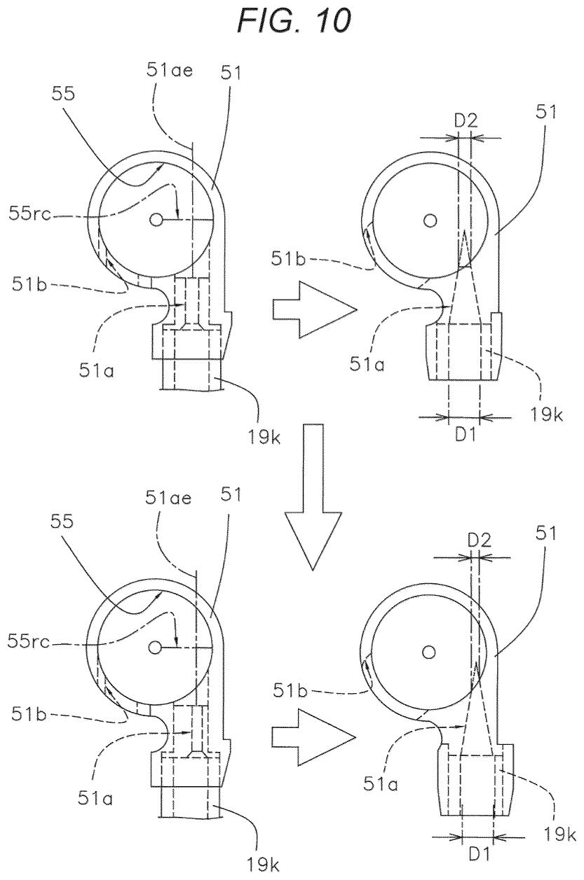

The blow hole 51a is tapered. A tube insertion port 51c into which the eighth tube 19k is inserted is formed in front of the blow hole 51a. The tube insertion port 51c has a diameter of, for example, 4 mm and a length of 4 mm or more in order to make it difficult for the eighth tube 19k to come off. For example, a diameter D1 of an inlet is 3 mm (see FIG. 10). The blow hole 51a has a shape in which a diameter D2 of a circle is 1 mm, the circle being obtained by cutting, at a point where a center line of a virtual cone intersects with the annular movement path 55, the cone along a plane orthogonal to the center line (see FIG. 10). When the blow hole 51a is tapered, the velocity of the compressed gas at the time of exiting the blow hole 51a is higher than the velocity of the compressed gas at the time of entering the blow hole 51a.

FIG. 10 illustrates four types of vibration cases 51 of the vibrator 50. In two types of vibration cases 51 in the upper part of FIG. 10, the blow hole 51a is formed such that an extension line 51ae of a central axis of the blow hole 51a passes through a center of a rectangular cross section 55rc cut along a plane passing through a central axis of the annular movement path 55. The central axis of the blow hole 51a is a central axis of a column in the vibration case 51 on the left side and a central axis of a cone in the vibration case 51 on the right side.

In two types of vibration cases 51 in the lower part of FIG. 10, the blow hole 51a is formed such that the extension line 51ae of the central axis of the blow hole 51a passes between the center of the rectangular cross section 55rc cut along the plane passing through the central axis of the annular movement path 55 and an outer wall of the annular movement path 55.

In the two types of vibration cases 51 on the left side of FIG. 10, the blow hole 51a is a columnar hole having an inner diameter smaller than an inner diameter of the eighth tube 19k.

In the two types of vibration cases 51 on the right side of FIG. 10, as described above, the blow hole 51a is substantially based on the cone, and has a shape in which a tip portion of the cone is cut by the annular movement path 55.

Although any of the four types illustrated in FIG. 10 may be adopted as a shape of the vibration case 51 of the vibrator 50, in the following description, a case where the vibration case 51 on the right side in the lower part of FIG. 10 is used will be described.

### (4) Operation of Powder Spray Device

### (4-1) Structure of On/Off Switch

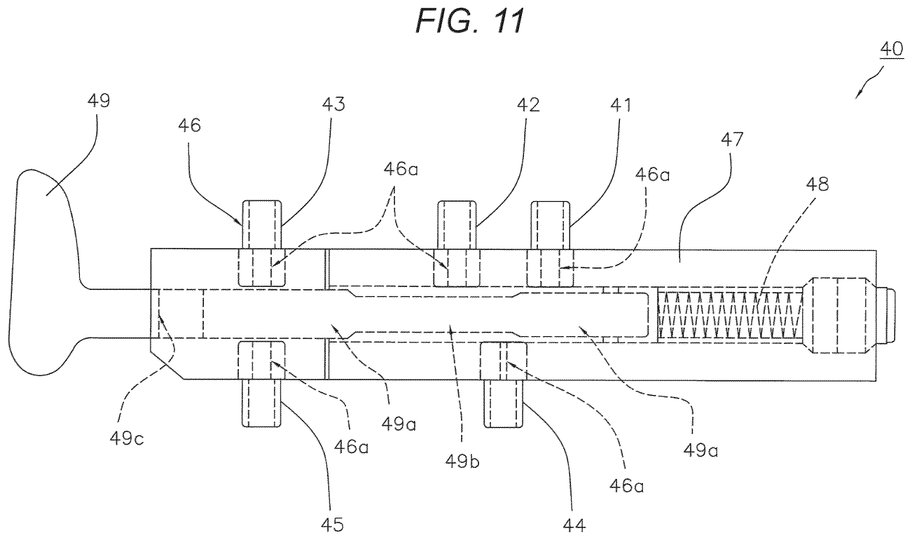

FIG. 11 illustrates an example of the on/off switch 40. A state illustrated in FIG. 11 is a state before the trigger lever 49 is pushed (a state before the coil spring 48 is pushed and the clastic deformation increases). As described above, a part of the rod-shaped portion of the trigger lever 49 is inserted into the valve case 47 of the on/off switch 40.

The on/off switch 40 is configured to be capable of adjusting a repulsive force of the coil spring 48 generated when the trigger lever 49 is pushed. Therefore, the operator of the on/off switch 40 can push the trigger lever 49 with an appropriate force, and can release the trigger lever 49 to automatically return to the trigger-off state.

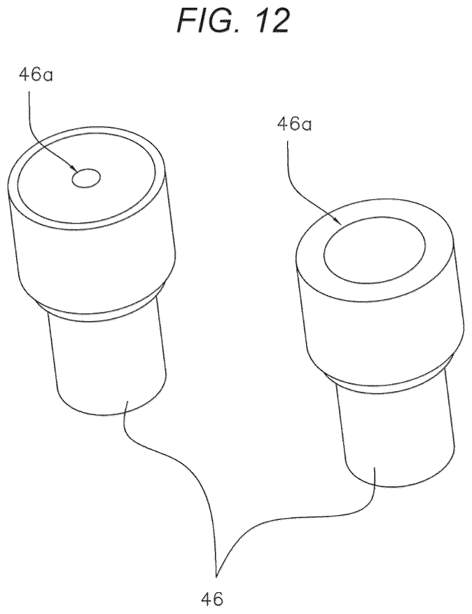

The first joint 41, the second joint 42, the third joint 43, the fourth joint 44, and the fifth joint 45 of the on/off switch 40 are formed by fitting joint parts 46 (see FIG. 12) into the valve case 47. Some of the joint parts 46 have flow rate adjustment holes 46a with different inner diameters. In the example of the on/off switch 40 illustrated in FIG. 11, the inner diameter of the flow rate adjustment hole 46a of the fourth joint 44 is 1 mm, and the inner diameters of the flow rate adjustment holes 46a of the first joint 41, the second joint 42, the third joint 43, and the fifth joint 45 are 3 mm. In the on/off switch 40 illustrated in FIG. 11, a combination of the inner diameters of the flow rate adjustment holes 46a of the first joint 41 to the fifth joint 45 can be appropriately changed by changing the joint parts 46. These flow rate adjustment holes 46a serve to narrow an inner diameter of a flow passage including the gas distribution path 19, the on/off switch 40, the first gas flow path 31, the second gas flow path 32, and the third gas flow path 33.

The rod-shaped portion of the trigger lever 49 has a columnar shape and includes a large diameter portion 49a having a larger diameter, a small diameter portion 49b having a smaller diameter, and a communication hole 49c.

In the state (trigger-off state) before the trigger lever 49 is pushed, the flow rate adjustment hole 46a of the first joint 41 is blocked by the large diameter portion 49a, and the compressed gas does not flow through the first joint 41. In the trigger-off state, the small diameter portion 49b is present in front of the fourth joint 44 and the second joint 42, and the compressed gas flows from the fourth joint 44 to the second joint 42 through a gap between the small diameter portion 49b and the valve case 47. In the trigger-off state, the flow rate adjustment holes 46a of the fifth joint 45 and the third joint 43 are blocked by the large diameter portion 49a, and the compressed gas does not flow from the fifth joint 45 to the third joint 43.

In the state (trigger-on state) where the trigger lever 49 is pushed, the small diameter portion 49b is present in front of the first joint 41, the second joint 42, and the fourth joint 44, and the compressed gas flows from the fourth joint 44 to the first joint 41 and the second joint 42 through the gap between the small diameter portion 49b and the valve case 47. In the trigger-on state, the flow rate adjustment holes 46a of the fifth joint 45 and the third joint 43 communicate with each other through the communication hole 49c, and the compressed gas flows from the fifth joint 45 to the third joint 43.

Note that an inner diameter of the flow passage including the gas distribution path 19, the first gas flow path 31, the second gas flow path 32, and the third gas flow path 33 are set to be equal to or larger than the maximum diameter of the flow rate adjustment holes 46a. Thus, the distribution of a flow rate of the compressed gas flowing through the first gas flow path 31, the second gas flow path 32, and the third gas flow path 33 can be adjusted by the flow rate adjustment holes 46a of the joint parts 46.

### (4-2) Flow Rate Adjustment in Powder Spray Gun

An air volume of the third gas flow path 33 is preferably configured to be equal to or larger than a total air volume of the first gas flow path 31 and the second gas flow path 32 during a spray of the powder. With such a configuration, the vibrator 50 can be sufficiently vibrated.

As a combination of the inner diameters of the flow rate adjustment holes 46a of the joint parts 46 for achieving the air volumes as described above, the inner diameter of the flow rate adjustment hole 46a of the fifth joint 45 is set to be larger than the inner diameter of the flow rate adjustment hole 46a of the fourth joint 44. Thus, a more air volume is distributed toward a vibration side (the third gas flow path 33) than a spray side (the first gas flow path 31 and the second gas flow path 32). In the following description, for example, “the inner diameter of the flow rate adjustment hole 46a of the fifth joint 45” is sometimes abbreviated and expressed as “the inner diameter of the fifth joint 45”.

In the above case, the inner diameter of the third joint 43 is set to be equal to or larger than the inner diameter of the fifth joint 45. When the inner diameter of the third joint 43 is set to be smaller than the inner diameter of the fifth joint 45, the air volume decreases due to the influence of the third joint 43. Therefore, the inner diameter of the third joint 43 is set to be larger than the inner diameter of the fourth joint 44 when the inner diameter of the third joint 43 is set to be smaller than the inner diameter of the fifth joint 45 and the air volume of the third gas flow path 33 is adjusted by the inner diameter of the third joint 43.

As described above, when the air volume of the third gas flow path 33 is larger than the total air volume of the first gas flow path 31 and the second gas flow path 32, the air volumes of the first gas flow path 31 and the second gas flow path 32 are not necessarily equal. However, when the air volume of the first gas flow path 31 is set to be larger than the air volume of the second gas flow path 32, the compressed gas is likely to leak into the first gas flow path 31 in the trigger-off state. If the compressed gas flows into the first gas flow path 31 in the trigger-off state, the powder may leak from the nozzle 12 in the trigger-off state. Therefore, it is preferable to set the air volume of the second gas flow path 32 to be equal to or larger than the air volume of the first gas flow path 31 such that the compressed gas hardly leaks into the first gas flow path 31 in the trigger-off state. In other words, it is preferable to set the inner diameter of the flow rate adjustment hole 46a of the second joint 42 to be equal to or larger than the inner diameter of the flow rate adjustment hole 46a of the first joint 41.

That is, it is preferable that the inner diameter of the fifth joint 45>the inner diameter of the fourth joint 44, the inner diameter of the third joint 43>the inner diameter of the fifth joint 45, and the inner diameter of the second joint 42>the inner diameter of the first joint 41.

Alternatively, it is preferable that the inner diameter of the third joint 43>the inner diameter of the fourth joint 44, the inner diameter of the third joint 43≤the inner diameter of the fifth joint 45, and the inner diameter of the second joint 42>the inner diameter of the first joint 41.

In a case where there is a difference in inner diameter, it is preferable to set the inner diameters at a ratio of 1:2 to 1:10. For example, when the inner diameter of the fifth joint 45 is set to be larger than the inner diameter of the fourth joint 44, for example, the inner diameter of the fifth joint 45 is set in the range of 1 mm to 5 mm if the inner diameter of the fourth joint 44 is 0.5 mm. Alternatively, when the inner diameter of the fifth joint 45 is set to be larger than the inner diameter of the fourth joint 44, for example, the inner diameter of the fourth joint 44 is set in the range of 2.5 mm to 0.5 mm if the inner diameter of the fifth joint 45 is 5 mm.

The on/off switch 40 is configured to cause the compressed gas to flow only to the second gas flow path 32 when the trigger lever 49 is in the trigger-off state, and cause the compressed gas to flow to the first gas flow path 31, the second gas flow path 32, and the third gas flow path 33 when the trigger lever 49 is in the trigger-on state. The on/off switch 40 is configured such that the supply of the compressed gas to the third gas flow path 33 is performed after a start of the supply of the compressed gas to the first gas flow path 31 when the trigger-off state is switched to the trigger-on state. As the operation of the on/off switch 40 at this time, in the trigger-off state, the first joint 41 and the third joint 43 are closed by the large diameter portion 49a of the trigger lever 49, and the small diameter portion 49b is present in front of the second joint 42 so that the second joint 42 is opened. When the trigger lever 49 is slightly pushed, the third joint 43 is closed by the large diameter portion 49a, and the small diameter portion 49b is present in front of the first joint 41 so that the second joint 42, and the first joint 41 and the second joint 42 are opened. When the trigger lever 49 is further slightly pushed, the third joint 43 coincides with the communication hole 49c, and the small diameter portion 49b is present in front of the first joint 41 and the second joint 42 so that the first joint 41, the second joint 42, and the third joint 43 are opened. As a result, the powder supply unit 20 can be vibrated by the vibrator 50 at a timing later than the supply of the compressed gas to the first gas flow path 31, and the powder can be smoothly supplied and dispersed into the compressed gas.

### Second Embodiment

### (5) Overall Configuration of Powder Spray Device

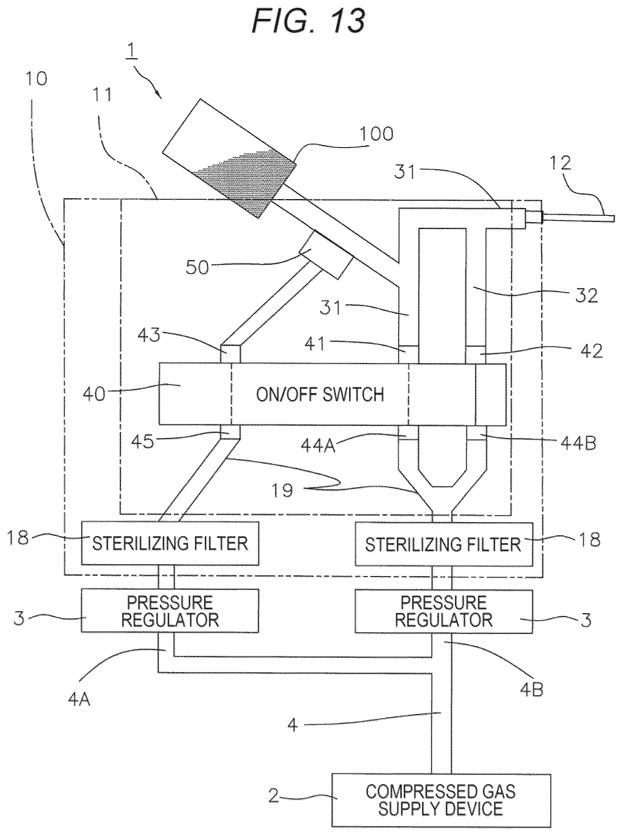

As illustrated in FIG. 13, the powder spray device 1 of a second embodiment includes the powder spray gun 10, the external gas flow path 4 having two branches, two pressure regulators 3, and the compressed gas supply device 2. The powder spray device 1 of the first embodiment has a configuration in which compressed gas flows into the gas distribution path 19 of the powder spray gun 10 through the single external gas flow path 4.

In the powder spray device 1 of the second embodiment, the external gas flow path 4 branches into two flow paths of a first external flow path 4A and a second external flow path 4B downstream of the compressed gas supply device 2. One pressure regulator 3 is disposed in each of the first external flow path 4A and the second external flow path 4B. In the powder spray device 1 of the second embodiment, a total air volume of the first gas flow path 31 and the second gas flow path 32 and an air volume of the third gas flow path 33 can be distributed by the two pressure regulators 3. As a result, the powder spray device 1 of the second embodiment can be adjusted by the pressure regulator 3 such that the air volume of the third gas flow path 33 is equal to or larger than the total air volume of the first gas flow path 31 and the second gas flow path 32 during a spray of powder without adjusting an inner diameter of the fourth joint 44 and an inner diameter of the fifth joint 45 by the on/off switch 40.

In the powder spray device 1 of the second embodiment, since the sterilizing filter 18 is provided in each of the bifurcate first external flow path 4A and second external flow path 4B, the number of the sterilizing filters 18 as well as the number of the pressure regulators 3 increases as compared with the powder spray device 1 of the first embodiment.

On the upstream side of the on/off switch 40, a flow passage in the housing 11 of the second embodiment is divided into three flow paths which correspond to the first gas flow path 31 to the third gas flow path 33, respectively. Therefore, the on/off switch 40 is provided with, as the fourth joint 44, a joint 44A for the first gas flow path corresponding to the first joint 41 and a joint 44B for the second gas flow path corresponding to the second joint 42. Also in the on/off switch 40 of the second embodiment, the air volume of the first gas flow path 31 and the air volume of the second gas flow path 32 can be adjusted by an inner diameter of the first joint 41 and an inner diameter of the second joint 42, or inner diameters of the joints 44A and 44B.

In the powder spray device 1 of the second embodiment, the configurations described in the first embodiment can be used for configurations other than differences from the powder spray device 1 of the first embodiment described above, and thus the description thereof will be omitted here.

### Third Embodiment

### (6) Overall Configuration of Powder Spray Device

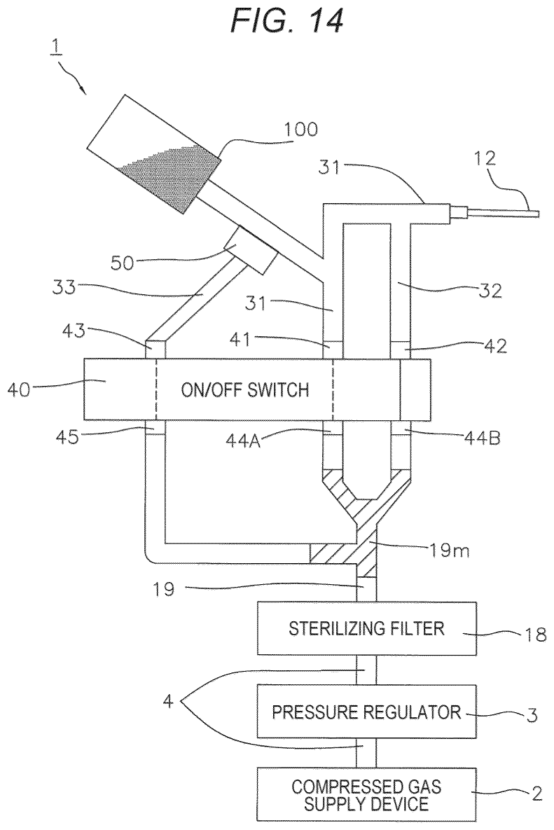

As illustrated in FIG. 14, in the powder spray device 1 of a third embodiment, one external gas flow path 4 is distributed to three tubes 19p, 19q, and 19r by a trifurcate part 19m upstream of the on/off switch 40.

The on/off switch 40 of the third embodiment is provided with the two joints 44A and 44B as the fourth joint 44 similarly to the on/off switch 40 of the second embodiment. By appropriately setting inner diameters of the joints 44A and 44B and an inner diameter of the fifth joint 45, an air volume of the third gas flow path 33 can be set to be equal to or larger than a total air volume of the first gas flow path 31 and the second gas flow path 32 during a spray of powder. In addition, in the on/off switch 40 of the third embodiment, the air volume of the first gas flow path 31 and the air volume of the second gas flow path 32 can be adjusted by setting a ratio between the inner diameter of the joint 44A and the inner diameter of the joint 44B or setting a ratio between an inner diameter of the first joint 41 and an inner diameter of the second joint 42.

Alternatively, by appropriately setting the inner diameter of the first joint 41, the inner diameter of the second joint 42, and an inner diameter of the third joint 43, the air volume of the third gas flow path 33 can be set to be equal to or larger than the total air volume of the first gas flow path 31 and the second gas flow path 32 during the spray of the powder. In addition, the air volume of the first gas flow path 31 and the air volume of the second gas flow path 32 can be adjusted by setting the ratio between the inner diameter of the first joint 41 and the inner diameter of the second joint 42 or setting the ratio between the inner diameters of the joints 44A and 44B.

In the powder spray device 1 of the third embodiment, the configurations described in the first embodiment can be used for configurations other than differences from the powder spray device 1 of the first embodiment described above, and thus the description thereof will be omitted here.

### (7) Modifications

### (7-1) Modification A

In the first to third embodiments, the case where the powder is contained in the powder container (the vial 100) separate from the powder supply unit 20 has been described. However, the powder may be contained in a storage that is integrated with the powder supply unit 20 and communicates with the powder supply path 22.

### (7-2) Modification B

In the first to third embodiments, the case where the vibrator 50 in which the columnar weight 54 rotates with the compressed gas in the annular movement path 55 is used has been described. However, what rotates in the annular movement path 55 of the vibrator 50 is not limited to the columnar weight 54.

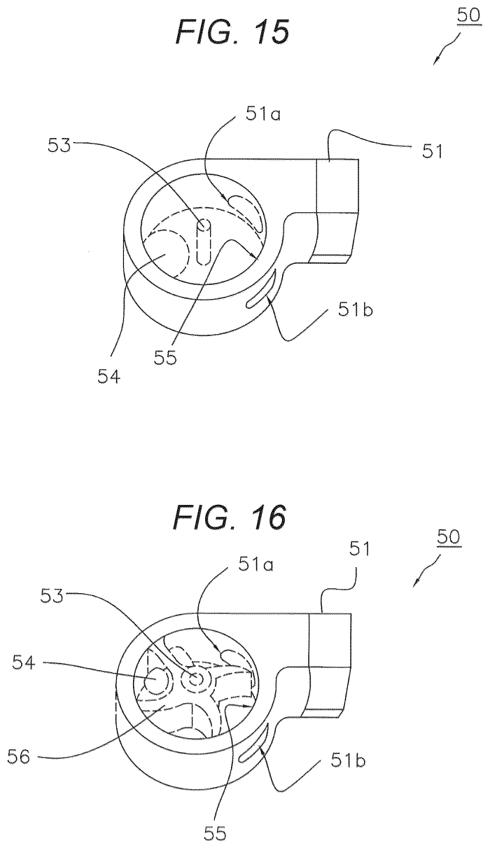

In the vibrator 50 illustrated in FIG. 15, the rotating weight 54 is spherical. In the vibrator 50 of FIG. 15, the spherical weight 54 moves in the annular movement path 55 by the compressed gas blown from the blow hole 51a and discharged from the exhaust hole 51b, which is similar to the columnar weight 54 of the vibrator 50 in the first to third embodiments. A cross section of the annular movement path 55 cut along a plane passing through the central column 53 illustrated in FIG. 15 has a rectangular shape, but may have a shape close to a circular cross section cut along a plane passing through a center point of the spherical weight 54.

In the vibrator 50 illustrated in FIG. 16, the weight 54 may be attached to one of blades of a wind turbine 56. In the vibrator 50 of FIG. 16, the wind turbine 56 is rotated by the compressed gas introduced from the blow hole 51a and discharged from the exhaust hole 51b, and the weight 54 moves in the annular movement path 55.

There is another vibrator in which a rotating body whose center of gravity deviates from a rotation center is rotated by the compressed gas.

### (7-3) Modification C

In the first to third embodiments, the case where the supply of the compressed gas to the third gas flow path 33 is performed after the start of the supply of the compressed gas to the first gas flow path 31 at the time of switching between the trigger-off state and the trigger-on state by the on/off switch 40 has been described. However, the supply of the compressed gas to the third gas flow path 33 may be performed simultaneously with the start of the supply of the compressed gas to the first gas flow path 31 at the time of switching between the trigger-off state and the trigger-on state by the on/off switch 40.

In addition, the supply of the compressed gas to the third gas flow path 33 may be performed earlier than the start of the supply of the compressed gas to the first gas flow path 31 at the time of switching between the trigger-off state and the trigger-on state by the on/off switch 40.

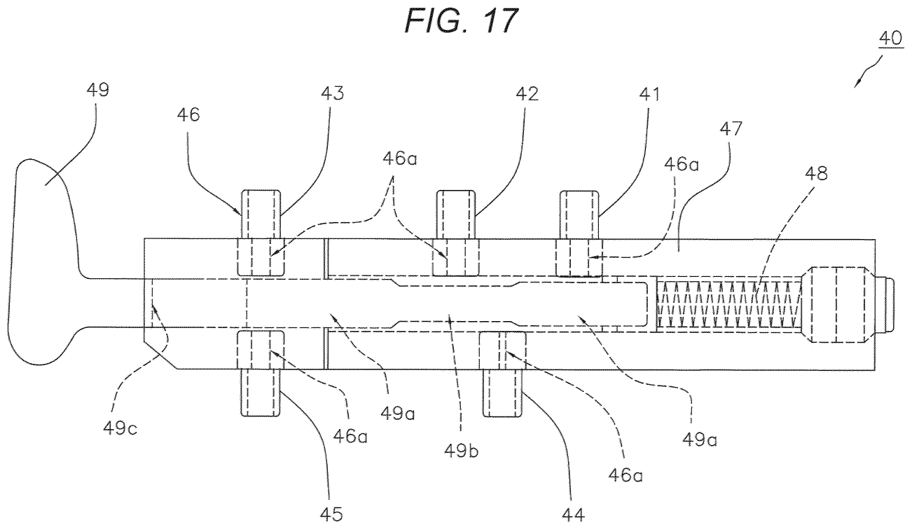

In order to supply the compressed gas to the third gas flow path 33 at a timing earlier than the first gas flow path 31, for example, the structure of the on/off switch 40 illustrated in FIG. 17 may be changed. For example, the structure may be changed such that the fifth joint 45 and the third joint 43 communicate with each other through the communication hole 49c first when the trigger lever 49 is pushed, and then the first joint 41 and the fourth joint 44 communicate with each other through the small diameter portion 49b as the trigger lever 49 is further pushed. As the operation of the on/off switch 40 at this time, in the trigger-off state, the first joint 41 and the third joint 43 are closed by the large diameter portion 49a of the trigger lever 49, and the small diameter portion 49b is present in front of the second joint 42 so that the second joint 42 is opened. When the trigger lever 49 is slightly pushed, the first joint 41 is closed by the large diameter portion 49a, the third joint 43 coincides with the communication hole 49c, and the small diameter portion 49b is present in front of the second joint 42 so that the third joint 43 and the second joint 42 are opened. When the trigger lever 49 is further slightly pushed, the small diameter portion 49b is present in front of the first joint 41 and the second joint 42, and the third joint 43 coincides with the communication hole 49c so that the first joint 41, the second joint 42, and the third joint 43 are opened.

In addition, it is also possible to adopt a configuration in which the compressed gas is supplied to the second gas flow path 32 and the third gas flow path 33 in the trigger-off state, and the compressed gas is supplied to all of the first gas flow path 31, the second gas flow path 32, and the third gas flow path 33 in the trigger-on state.

### (7-4) Modification D

In the first to third embodiments, the case where the compressed gas flows to the second gas flow path 32 in both the trigger-off state and the trigger-on state has been described. However, supply and non-supply of the compressed gas to the second gas flow path 32 may be switched by adding a switching pattern of the on/off switch 40. For example, the on/off switch 40 can be configured such that the compressed gas starts to flow to the first gas flow path 31 and the third gas flow path 33 after the compressed gas starts to flow to the second gas flow path 32.

### (7-5) Modification E

In the first to third embodiments, the on/off switch 40 is configured to change the flow rate adjustment hole 46a using the joint part 46. However, in a case where it is unnecessary to change the flow rate adjustment hole 46a, the on/off switch 40 may be configured such that the joint part 46 cannot be replaced by integrally forming the joint part 46 and the valve case 47.

### (7-6) Modification F

Although the case where the powder supply path 22 has the truncated cone shape has been described in the first to third embodiments, the shape of the powder supply path 22 is not limited to the truncated cone shape. The shape of the powder supply path 22 may be, for example, a quadrangular frustum, a cylinder, or a shape changing from a cone to a cylinder.

### (7-7) Modification G

In the first to third embodiments, the case where the flow rate adjustment hole 46a is provided in the on/off switch 40 using the joint part 46 has been described. However, a place where a flow rate adjustment hole is provided is not limited to the on/off switch 40. The flow rate adjustment hole 46a may be provided at an appropriate place in a flow passage including the gas distribution path 19, the on/off switch 40, the first gas flow path 31, the second gas flow path 32, and the third gas flow path 33.

### (7-8) Modification H

In the first to third embodiments, the case where the vibrator 50 is attached to the powder supply unit 20 and the powder supply unit 20 and the disperser 34 are vibrated by the vibrator 50 has been described. However, the vibrator 50 may transmit vibration to the powder supply unit 20 and the disperser 34 via another member without being attached to the powder supply unit 20.

### (7-9) Modification I

In the first to third embodiments, the case where only the single on/off switch 40 is provided in the powder spray gun 10 has been described. However, an on/off switch may include a plurality of switches. For example, an on/off switch may include a first switch that switches between supply and non-supply of compressed gas to the first gas flow path 31, a second switch that switches between supply and non-supply of compressed gas to the second gas flow path 32, and a third switch that switches between supply and non-supply of compressed gas to the third gas flow path 33. In addition, for example, an on/off switch may include a first switch that switches between supply and non-supply of compressed gas to the first gas flow path 31 and a second switch that switches between supply and non-supply of compressed gas to the second gas flow path 32 and the third gas flow path 33. When the on/off switch includes the plurality of switches as described above, the respective switches may be provided in the housing 11 of the powder spray gun 10 or may be provided outside the housing 11. For example, the first switch for switching between the supply and the non-supply of the compressed gas to the first gas flow path 31 may be provided in the housing 11, and the second switch for switching between the supply and the non-supply of the compressed gas to the second gas flow path 32 and the third gas flow path 33 may be provided in the external gas flow path 4.

As the first switch to the third switch, for example, it is possible to use a slide-type switch in which a flow path is closed in an off state, and an internal hole is moved by moving a slide in an on state to make the hole reach a position of the flow path so that gas flows to the flow path through the hole.

### (7-10) Modification J

In the first to third embodiments, the case where the on/off switch 40 is provided in the housing 11 of the powder spray gun 10 has been described. However, the on/off switch 40 may be provided outside the housing 11 of the powder spray gun 10.

### (7-11) Modification K

In the first to third embodiments, the case where a part of the gas distribution path 19 is provided in the housing 11 of the powder spray gun 10 has been described. However, the entire gas distribution path 19 may be provided outside the housing 11 of the powder spray gun 10.

### (8) Features

(8-1)

The powder spray gun 10 according to the first to third embodiments described above includes the powder supply unit 20, the first gas flow path 31, the second gas flow path 32, the third gas flow path 33, the gas distribution path 19, the vibrator 50, the on/off switch 40, and the housing 11.

In the powder spray gun 10, the vibrator 50 can vibrate the powder supply unit 20 supported by the housing 11 in a vibratable manner by compressed gas supplied from the third gas flow path 33 to the vibrator 50. The vibration of the powder supply unit 20 is transmitted to the disperser 34. Due to the vibration of the powder supply unit 20 and the disperser 34, even powder having low bulk density and low fluidity can be smoothly supplied from the powder supply unit 20 to the disperser 34 of the first gas flow path 31. In a state where the spray gun is turned on, the compressed gas in the second gas flow path 32 is added to the compressed gas in which the powder is uniformly dispersed in the disperser 34 by the compressed gas flowing through the first gas flow path 31 with appropriate air volume, whereby the compressed gas in which the powder is uniformly dispersed can be sufficiently blown out.

In a state where the powder spray gun 10 is turned off, a spray of the powder is stopped, and the compressed gas flows only to the second gas flow path 32, so that it is possible to prevent high-humidity air generated in a human body from flowing back into the nozzle 12. The on/off switch 40 can switch between supply and non-supply of the compressed gas from the gas distribution path 19 to each of the first gas flow path 31 and the third gas flow path 33 at an appropriate timing. The powder spray gun 10 uses the compressed gas as a power source for the vibration and does not include an electrical mechanism, and thus can be easily sterilized and can smoothly and uniformly blow out even the powder having low bulk density and low fluidity from the nozzle 12.

(8-2)

The powder spray gun 10 according to the first to third embodiments described above is configured such that an air volume of the third gas flow path 33 is equal to or larger than a total air volume of the first gas flow path 31 and the second gas flow path 32 during the spray of the powder. This powder spray gun can sufficiently supply sufficient compressed gas from the third gas flow path 33 to the vibrator 50, and can smoothly and uniformly blow out the powder in a stable manner.

(8-3)

In the powder spray gun 10 according to the first to third embodiments described above, the flow rate adjustment hole 46a that narrows an inner diameter of a flow passage such that the air volume of the third gas flow path 33 becomes equal to or larger than the total air volume of the first gas flow path 31 and the second gas flow path 32 during the spray of the powder is provided in the flow passage including the gas distribution path 19, the on/off switch 40, the first gas flow path 31, the second gas flow path 32, and the third gas flow path 33. As a result, the powder spray gun 10 can easily adjust the air volumes of the first gas flow path 31, the second gas flow path 32, and the third gas flow path 33 to satisfy a desired relationship with a simple structure.

(8-4)

As described in the first to third embodiments and Modification C, the on/off switch 40 is configured to cause the compressed gas to flow only to the second gas flow path 32 when the trigger lever 49 is in a trigger-off state, and cause the compressed gas to flow to the first gas flow path 31, the second gas flow path 32, and the third gas flow path 33 when the trigger lever 49 is in a trigger-on state.

It is configured such that the supply of the compressed gas to the first gas flow path 31 is performed simultaneously with or earlier than a start of the supply of the compressed gas to the third gas flow path 33 when the trigger-off state is switched to the trigger-on state. Therefore, the powder spray gun 10 can supply the compressed gas to the first gas flow path 31 before the vibration by the vibrator 50 is applied to the powder supply unit 20 and the disperser 34, and can smoothly and uniformly blow out the powder from the start of the supply of the compressed gas to the first gas flow path 31. For example, it is possible to prevent a phenomenon called “dripping” in which powder is blown out in a solidified state without being dispersed in gas when the spray of the powder is started.

(8-5)

In the powder spray gun 10 according to the first to third embodiments described above, the pin 11k, which is a separation unit of the housing 11 separates the second gas flow path 32 and the powder supply unit 20 not to overlap each other in a narrow portion (Z direction in FIG. 2) of the housing 11. As a result, the powder spray gun 10 can prevent a situation in which the powder cannot be smoothly and uniformly blown out as the vibration of the powder supply unit 20 and the disperser 34 caused by the vibrator 50 is limited by the second gas flow path 32 and the housing 11.

(8-6)

In the vibrator 50 in the first to third embodiments described above, the weight 54 having a columnar shape is disposed in the annular movement path 55. The vibration case 51 of the vibrator 50 has the blow hole 51a connected to the third gas flow path 33 to blow the compressed gas into the movement path 55 and the exhaust hole 51b to discharge the compressed gas from the movement path 55. The movement path 55 has a rectangular cross section perpendicular to a moving direction of the columnar weight 54. The weight 54 moves in the movement path by the compressed gas blown into the movement path 55 from the blow hole 51a. In the powder spray gun 10 configured as described above, the columnar weight 54 blocks the movement path 55 so that the compressed gas leaking from a gap between the weight 54 and the movement path 55 can be reduced. In addition, the weight 54 is less likely to be caught by the movement path 55 since the weight 54 has the columnar shape, so that the columnar weight 54 rotates well by the compressed gas, and the vibrator 50 efficiently vibrates.

(8-7)

The powder spray device 1 in the first embodiment and the third embodiment includes one pressure regulator 3, and the powder spray gun 10 includes one sterilizing filter 18. The gas distribution path 19 communicates with the first gas flow path 31, the second gas flow path 32, and the third gas flow path 33 downstream of the single sterilizing filter 18. The powder spray device 1 can include the single pressure regulator 3 and the single sterilizing filter 18 with the configuration branching into the first gas flow path 31, the second gas flow path 32, and the third gas flow path 33, so that an increase in the number of the pressure regulators 3 and the sterilizing filters 18 can be prevented.

Although the first to third embodiments of the present disclosure have been described above, the present invention is not limited to the above embodiments, and various modifications can be made without departing from the gist of the invention. In particular, the plurality of embodiments and modifications described in the present specification can be combined in any manner as necessary.

What is claimed is:

1. A powder spray gun comprising:
a powder supply unit including an upper attachment port to which a powder container is attachable or a storage in which powder is contained, a powder supply path through which the powder falling from the upper attachment port or the storage by gravity passes, and a powder supply port communicating with the powder supply path;
a first gas flow path including a first gas inlet, a disperser that disperses the powder supplied from the powder supply port into compressed gas entering from the first gas inlet, and a discharge port that discharges the compressed gas in which the powder is dispersed;
a second gas flow path that includes a second gas inlet, is connected to the first gas flow path between the discharge port and the disperser, and causes the compressed gas entering from the second gas inlet to flow to the first gas flow path;
a vibrator that generates a vibratory force for vibrating the powder supply unit and the disperser by the compressed gas;
a third gas flow path that includes a third gas inlet and causes the compressed gas entering from the third gas inlet to flow to the vibrator;
a gas distribution path configured to distribute and supply the compressed gas to the first gas inlet, the second gas inlet, and the third gas inlet;
an on/off switch that is connected to at least the first gas inlet and the gas distribution path and switches between supply and non-supply of the compressed gas at least from the gas distribution path to the first gas inlet; and
a housing that accommodates the powder supply unit, the first gas flow path, the second gas flow path, the third gas flow path, and the vibrator and supports the powder supply unit in a vibratable manner.

2. The powder spray gun according to claim 1, wherein an air volume of the third gas flow path is equal to or larger than a total air volume of the first gas flow path and the second gas flow path during a spray of the powder.

3. The powder spray gun according to claim 2, further comprising a flow rate adjustment hole in a flow passage including the gas distribution path, the on/off switch, the first gas flow path, the second gas flow path, and the third gas flow path, the flow rate adjustment hole narrowing an inner diameter of the flow passage to make the air volume of the third gas flow path be equal to or larger than the total air volume of the first gas flow path and the second gas flow path during the spray of the powder.

4. The powder spray gun according to claim 1, wherein the on/off switch includes a trigger lever, and is configured to cause the compressed gas to flow only to the second gas flow path when the trigger lever is in a trigger-off state, cause the compressed gas to flow to the first gas flow path, the second gas flow path, and the third gas flow path when the trigger lever is in a trigger-on state, and cause the compressed gas to be supplied to the first gas flow path simultaneously with or earlier than a start of supply of the compressed gas to the third gas flow path when the trigger-off state is switched to the trigger-on state.

5. The powder spray gun according to claim 1, wherein the housing includes a separation unit that separates the second gas flow path and the powder supply unit not to overlap each other at a narrow portion of the housing.

6. The powder spray gun according to claim 1, wherein
the vibrator includes a movement path having an annular shape, a weight that has a columnar shape and is disposed in the movement path, a blow hole connected to the third gas flow path to blow the compressed gas into the movement path, and an exhaust hole discharging the compressed gas from the movement path,
the movement path has a rectangular cross section perpendicular to a moving direction of the weight having the columnar shape, and
the weight moves in the movement path by the compressed gas blown into the movement path from the blow hole.

7. A powder spray device comprising:
the powder spray gun according to claim 1;
one external gas flow path that sends the compressed gas to the gas distribution path of the powder spray gun;
a compressed gas supply device that is connected to the external gas flow path and supplies the compressed gas to the external gas flow path; and
one pressure regulator that is disposed in the external gas flow path and adjusts a pressure of the compressed gas supplied from the external gas flow path to the gas distribution path,
wherein
the powder spray gun includes one sterilizing filter that is disposed in the gas distribution path and sterilizes the compressed gas, and
the gas distribution path communicates with the first gas flow path, the second gas flow path, and the third gas flow path downstream of the sterilizing filter.

8. The powder spray gun according to claim 2, wherein the on/off switch includes a trigger lever, and is configured to cause the compressed gas to flow only to the second gas flow path when the trigger lever is in a trigger-off state, cause the compressed gas to flow to the first gas flow path, the second gas flow path, and the third gas flow path when the trigger lever is in a trigger-on state, and cause the compressed gas to be supplied to the first gas flow path simultaneously with or earlier than a start of supply of the compressed gas to the third gas flow path when the trigger-off state is switched to the trigger-on state.

9. The powder spray gun according to claim 2, wherein the housing includes a separation unit that separates the second gas flow path and the powder supply unit not to overlap each other at a narrow portion of the housing.

10. The powder spray gun according to claim 2, wherein
the vibrator includes a movement path having an annular shape, a weight that has a columnar shape and is disposed in the movement path, a blow hole connected to the third gas flow path to blow the compressed gas into the movement path, and an exhaust hole discharging the compressed gas from the movement path,
the movement path has a rectangular cross section perpendicular to a moving direction of the weight having the columnar shape, and
the weight moves in the movement path by the compressed gas blown into the movement path from the blow hole.

11. A powder spray device comprising:
the powder spray gun according to claim 2;
one external gas flow path that sends the compressed gas to the gas distribution path of the powder spray gun;
a compressed gas supply device that is connected to the external gas flow path and supplies the compressed gas to the external gas flow path; and
one pressure regulator that is disposed in the external gas flow path and adjusts a pressure of the compressed gas supplied from the external gas flow path to the gas distribution path,
wherein
the powder spray gun includes one sterilizing filter that is disposed in the gas distribution path and sterilizes the compressed gas, and
the gas distribution path communicates with the first gas flow path, the second gas flow path, and the third gas flow path downstream of the sterilizing filter.
